(19) United States
(12) Patent Application Publication
(10) Pub. No.: US 2022/0306928 A1
(43) Pub. Date: Sep. 29, 2022

(54) METHOD OF APPLYING AN INCRUSTATION INHIBITOR IN COMPLETION FLUIDS

(71) Applicant: Petróleo Brasileiro S.A. - Petrobras, Rio de Janeiro (BR)

(72) Inventors: Fernando Antonio Moreira Da Silva, Rio de Janeiro (BR); Francisca Ferreira Do Rosario, Rio de Janeiro (BR); Mario Germino Ferreira Da Silva, Rio de Janeiro (BR); Patricia Braga Gusmão, Rio de Janeiro (BR); Rosane Alves Fontes, Petrópolis (BR)

(21) Appl. No.: 17/692,473

(22) Filed: Mar. 11, 2022

(30) Foreign Application Priority Data
Mar. 24, 2021 (BR) 10 2021 005689 4

(51) Int. Cl. C09K 8/528

(52) U.S. Cl. CPC C09K 8/528

(57) ABSTRACT

The present invention relates to a method of applying incrustation inhibitor in completion fluids inside a reservoir in order to ensure the flow of well production. The present invention can be applied in throughout the well area, being directed to the reservoir areas for the management of incrustation and in the elevation and outflow areas, it will work to ensure the flow of production from the wells. It may also be applied as part of the technology used in the construction of wells in the completion phase in the operations to combat loss of circulation as part of the technology used in the completion fluids, it merely being necessary to plan for the addition of the inhibitor chemical product in the manufacture of the completion fluid.

### FIELD OF THE INVENTION

The present invention discloses a method of applying incrustation inhibitor in completion fluids applied in the field of oil reservoirs, with a view to ensuring production flows from wells.

### DESCRIPTION OF THE STATE OF THE ART

Generally speaking, in an oil production project for a producer field, the development of field production depends on ensuring that oil reaches the surface. This assurance of flow depends on certain variables that are normally defined by reservoir engineering in association with elevation and flow engineering.

Among factors that influence the assurance of production flow, particular importance is placed on the formation of saline incrustations, whose dimensions and location in the production system may create obstructions for the production of oil, thus generating losses.

Therefore, inhibiting the formation of incrustation or the removal thereof, is required in order to ensure the flow of oil production, as well as the economics of the production development project.

Currently, to solve the need for inhibition of reservoirs with a view to preventing the formation of incrustation, only chemical inhibition by means of inhibitor squeeze in reservoirs is used. However, this operation usually requires production stoppage at the well to allow for injection of the inhibitor squeeze in the producing formation, whereupon an inhibitor adsorption time is required for the reservoir rock. Once the adsorption time has elapsed, when the matrix rock adsorbs part of the incrustation inhibitor, the excess thereof is produced when the well is opened for production. This adsorption time is controlled to prevent any damage from occurring to the reservoir. During oil production, the inhibitor fluid that was adsorbed by the reservoir rock will begin a chemical desorption process, i.e., it will be gradually released with the water produced, thus inhibiting the formation of incrustation.

In light of the foregoing, the need arises for chemical inhibition of a common reservoir, along with the need to control circulation losses in the wells due to imbalance of the hydrostatic fluid column inside the well. This control is carried out through operations to combat the loss of circulation. During the operations to stop losses, typically, viscous flushing fluids and varied grain sizes of calcite (calcium carbonate) are pumped inside the well for the purpose of plugging the producer formation. In this operation, normally, a large volume of fluid is absorbed by the producing formation, until control of the loss of circulation is efficiently achieved.

Document BR1020170255905A2 discloses a treatment method that consists of injecting, sequentially or in a mixture, the incrustation inhibitor and polymer, and that sequential or mixed injection of the incrustation inhibitor and of the polymer, can triple the duration of the injection treatment, when compared to a treatment by injection using only the incrustation inhibitor. Furthermore, said reference discloses the use of incrustation inhibitors derived from phosphonate (1-155), sulfonate carboxylic phosphino acid and carboxylic non-ionic ter-polymer. In contrast, the present invention relates to a process of utilizing a chemical treatment that would be carried out in a well, be it loss of circulation, squeeze, acidification or injectivity testing, to serve as additive with incrustation inhibitor, the pre-flushing, treatment, overflush, and displacement being selected. The inhibited completion fluid is injected into the formation so as to inhibit incrustation inside the reservoir, during well production.

Document US2016208157A1 discloses a method of treating an underground formation, which may include obtaining a curable composition, e.g., a polyhedral olygomeric (FOSS), including at least one curable group. The method discloses the use of incrustation inhibitors in the process of treating the underground formation, and also the treatment of an underground formation, using substances derived from acrylates and phosphonates. However, said document does not relate to a process of utilizing chemical treatment operations, e.g., acidification, inhibition squeeze and incrustation removal or injectivity test. Therefore, said document is characterized as being only a treatment process for the underground producing formation. In contrast, the present invention relates to a process of utilization of chemical treatment operations, be it acidification, inhibition squeeze and incrustation removal or injectivity test.

Document PI10044000A2 discloses a technique for monitoring and reacting locally to conditions that are likely to cause incrustation precipitation around the equipment inside the well. Therefore, the document discloses that a monitoring and incrustation inhibition system inside the well is provided with a detection module and an injection module, the latter being operated to provide precise local injections inside the well, using incrustation-inhibiting chemical products. Thus, said reference is characterized by being only a treatment process inside a well, in the production string, and does not relate to a process consisting of the utilization of chemical treatment operations, whether it be acidification, inhibition squeeze and incrustation removal or injectivity testing to inject the inhibitor into the reservoir.

This being the case, no prior-art document discloses a method of applying inhibitor fluid in completion-fluid operations, such as the one of the present invention.

The present invention was developed with a view to solving said problems, whereby an incrustation inhibitor is added to the formulation of the completion fluid, which will be used during operations to combat loss of circulation in completed wells, both in siliciclastic formations and carbonate formations, as is the case of pre-salt.

It is thus important to emphasize that the present invention aims to reduce costs, since it relates to a method focused on taking advantage of treatments that are carried out in the operations to prevent the loss of circulation, both in terms of drilling and completion, and specifically in completion operations, injectivity testing, matrix acidification operations, inhibitor incrustation squeeze that normally require large volumes of fluids.

Another aspect of the invention is that the incrustation inhibitor to be used is not a fixed formulation product, but rather one that has optimal chemical compatibility with the treatment fluid that will be used in the oil well operation. Therefore, coverage includes all chemical classes of inhibitor products and, depending on the type of fluid that will be used in the drilling and/or completion of the oil well, the most advantageous product in terms of chemical compatibility will be selected.

Thus, the present invention prevents oil production losses in the event of generating incompatible mixtures with a high incrustation potential as a result of mixing the completion fluid with the fluid produced and reduction of the number of interventions by the stimulation vessel and also avoids interventions by the rig in the development phase.

### SUMMARY OF THE INVENTION

The present invention relates to a method of applying an incrustation inhibitor in completion fluids inside the producing formation consisting of utilizing chemical treatment operations, e.g., acidification, inhibition squeeze or incrustation removal, or injectivity testing in order to place the inhibitor fluid inside the reservoir.

The present invention may be fully applied through the wells area, being directed to the reservoirs area for the management of incrustation, and in the elevation and outflow area it will contribute to ensuring the flow of production from the wells. It may also be applied as part of the technology used in the construction of wells in the completion phase in the operations to prevent loss of circulation as part of the technology used in the completion fluids and is only necessary to plan for the addition of the inhibitor chemical product in the manufacture of the completion fluid.

### DETAILED DESCRIPTION OF THE INVENTION

The method of applying the incrustation inhibitor in completion fluids, according to the present invention, comprises the following steps:

1) Definition of the function and type of completion fluid, generally seawater-based fluids with or without incorporation of a loss-control agent, such as, for example, micronized calcite;

2) Selecting the inhibitor compatible with the completion fluid and the rock formation;

3) Approximate sizing of the volume of the incrustation inhibitor to be consumed;

4) Incorporating the inhibitor into the fluid occurs in a tank or mixer located on the stimulation vessels or offshore rig.

In the operations to prevent loss of circulation, a viscous fluid is used, mixed with micronized calcite, having a granulometry as defined in accordance with the operating program. This mixture forms the flushing to combat the loss which is displaced by completion fluid, until it reaches the perforations. The incrustation inhibitor will be added to the completion fluid, which will be absorbed by the producing formation during the loss-control operation and, in this way, the inhibitor will be positioned inside the reservoir and thus the reservoir will be inhibited.

While the reservoir absorbs the fluid used in the operation to combat the loss due to the hydrostatic imbalance inside the well, the fluid with the incrustation inhibitor will be positioned inside the reservoir, thus generating a chemical inhibition against the formation of incrustation inside the reservoir.

Therefore, the solution achieved by the invention consists in utilizing the completion fluid used in the operations to combat the loss of circulation in order to inhibit incrustation in the reservoir by filling the porous spaces in the reservoir rock with the inhibited completion fluid. When the well is placed in production, this inhibited fluid positioned inside the reservoir will be produced together with the oil and will inhibit the formation of incrustation inside the reservoir.

The present patent application relates to the application of incrustation inhibitor in fluids used in: completion operations, providing the well with the equipment of the production string, while it may also be necessary to combat the loss of circulation; in injectivity testing used to evaluate injectivity of the formation in the range of interest; in matrix acidification operations; in the pre-flush fluids and displacement of the incrustation inhibitor squeeze.

Therefore, an inhibitor additive can be disposed in the various treatment flushes that will be used in the operations described, designed to leave the incrustation inhibitor product inside the reservoir, the aim of which is to generate initial protection in terms of inhibiting the formation of incrustation inside the reservoir.

Accordingly, the operation with completion fluids can be carried out by the UEP (Stationary Production Unit) with a stimulation vessel or a rig with or without the use of a stimulation vessel, in the various embodiments described above.

The method of the present invention focuses on treatments using special pumps and large volumes of chemical products that focus on various options of operation, in which a stimulation vessel and UEP are used, or rig with or without a stimulation vessel, of achieving the objective of performing injectivity test operations, and loss of circulation control operations, matrix acidification treatments, incrustation inhibition squeeze in the reservoir, the latter aiming to protect the entire maritime production system involving the reservoir, production string, wet Christmas tree, production lines, manifold, production riser, including surface equipment (Top-side).

By using remote pumping (bullhead) of the treatment in the well and/or in the reservoir, where the treatment volumes are in large proportions, which can be carried out by the operational unit with the assistance of a stimulation vessel, given the need to provide a high pumping capacity (high pressures) and even tank volumes, as well as certain tanks with special coatings, as in the case of formic acid, acetic and hydrochloric acid tanks, which are used in stimulation vessels during acidification operations. In the squeeze operations in the reservoirs, in order to inhibit incrustation formation, large volumes are used, and there are also operations to remove the incrustation in the reservoirs, which also use large volumes, as do the injectivity tests.

### Examples

The incrustation inhibitor was applied in the drilling phase of well MLL-60, which was subject to a high volume of seawater-based fluid loss during the drilling phase. The use of incrustation inhibitor added to seawater was advised.

Between November 2015 and January 2016, the well MLL-60 produced about 45,000 bbl of seawater injected in the drilling, in the production period of the well in FPSO-NIT, at which time the well BSW was near 6.5%. The PDG data at the time indicated that the well followed the natural depletion profile, with no evidence of increased damage in the well, which shows that no loss in production was associated with incrustation formation in this well.

In scenario evaluations for future application of the technology of the present invention, it was noted that various wells in Búzios showed evidence of incrustation after only a few weeks of production (BUZ-7, BUZ-4, BUZ-14, RJS-708), however, in various wells the injection of the inhibitor is being restricted due to problems with subsea injection.

Discussions and plans were made to include the squeeze inhibitor (under contract) in the injectivity or displacement test fluids in order to assess the effect of delaying chemical injection or lack of such.

Despite the indication of including the incrustation inhibitor in the completion or formation loss fluids, in a first stage of adapting this technology, the initial aim is to verify the inhibitor's action on the fluids injected near the well, such as the stimulation fluid and/or injectivity tests, where it would be possible to maintain better controls over the concentration of the inhibitor and track the behavior of the tracer element (phosphorus).

There are no problems with fluid compatibility of the inhibitor, since the inhibitor is added to the saline or displacement fluids and not to the acid stimulation package. There is the risk of high adsorption of the inhibitor in the rock, however, the recommended concentration of 1,000 ppmV is sufficient to maintain a minimum inhibitory concentration. The inhibitor concentration of 100 mg/L is deemed sufficient for more severe incrustation conditions.

Another relevant factor is that the added inhibitor does not affect the rheological properties for the injectivity tests, yet the dosage in 1/1000 ppt would not be sufficient to affect the viscosity of the fluid.

1. METHOD OF APPLYING AN INCRUSTATION INHIBITOR IN COMPLETION FLUIDS, characterized by comprising the following steps:
1) defining the function and type of seawater-based completion fluid, with optional incorporation of loss-control agent;
2) selecting the incrustation inhibitor compatible with the completion fluid and rock formation;
3) sizing the volume of the incrustation inhibitor to be consumed;
4) incorporating the incrustation inhibitor into the completion fluid, which will be absorbed by the producing formation during the operation to combat the loss and thus perform the positioning of the inhibitor inside the reservoir.

2. METHOD according to claim 1, characterized by the agent for combatting loss being micronized calcite.

3. METHOD, according to claim 1, characterized in that the incorporation of the incrustation inhibitor into the completion fluid occurs in a tank or mixer found in the stimulation vessels or offshore rigs.
